(19) United States
(12) Patent Application Publication
(10) Pub. No.: US 2006/0125392 A1
(43) Pub. Date: Jun. 15, 2006

(54) Sealing member, self-emitting panel, and method of manufacturing self-emitting panel

(75) Inventor: Yoichi Munekata, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/299,693

(22) Filed: Dec. 13, 2005

(30) Foreign Application Priority Data
Dec. 14, 2004 (JP) 2004-362067

(51) Int. Cl. H05B 33/04

(52) U.S. Cl. 313/512

(57) ABSTRACT

In a sealing method using a hermetic-sealing method, humidity in a sealing space is kept constant.

In a sealing member 103 which isolates a self-emitting device 101 of a self-emitting panel 150 having the self-emitting device 101 provided on a substrate 102 from open air, film formation is carried out on a base material of the sealing member 103 such that functional layers 107 each having insulating properties and adjusting humidity inside a sealing space 106 are formed on a recess 103b which faces the inside of the sealing space 106 formed of the sealing member 103 and a substrate 102, a side 103ab, and a bottom 103aa joined to the substrate 102.

### BACK GROUND OF THE INVENTION

1. Field of the Invention

The present invention relates to a sealing member, a self-emitting panel, and a method of manufacturing the self-emitting panel.

2. Description of the Related Art

A self-emitting panel using at least an organic electroluminescence device (hereinafter referred to as organic EL device) has been increasingly used for dot matrix type display panels for a mobile phone, a monitor for use in a vehicle, an operation monitor of a household appliance, a PC, and a television set, etc., as well as displays for various information apparatuses, light emitting devices, etc., such as a fixed display for a clock, a panel for advertisement, etc., a light source for a scanner, or a printer, alight, a back light for a liquid crystal, etc. The organic EL device has a structure in which an organic layer sandwiched by a pair of electrodes is formed on a substrate, and it is successfully thinned, and excellent invisibility, impact strength, etc.

As for the organic EL device, it is assumed that open air, water, light, etc. may be degradation factors in the organic EL device, and sealing methods are provided for protecting the organic EL device from the degradation factors. Generally, there are 1). a hermetic-sealing method in which a sealing space is formed by a substrate (such as glass, a plastic, quartz, etc.) which is a constituent element of the organic EL device, and a sealing member (such as metal, glass, etc.), 2). a film sealing method in which the sealing is carried out by a sealing film of SiO2, Al2O3, a photo-curable resin, etc., and 3). a solid sealing method in which a sealing agent, such as an epoxy resin, an elastomer, etc., is sandwiched between the substrate and the sealing member.

The hermetic-sealing method is often used, since the self-emitting panel using the organic EL device can be manufactured easily with a low cost. When this hermetic-sealing method is used, water, bled gases (reactive gas, released gas, etc.) etc. from an adhesive used in the case of joining the sealing member to the substrate and carrying out the sealing may remain inside the sealing space. The bled gases take place even if the organic EL device is fabricated in an inactive gas, and in a low moisture atmosphere. In order to protect the organic EL device from these degradation factors, a technique is disclosed in which, as an adsorption material for adsorbing the water inside the sealing space, a desiccant, such as an alkaline earth metal etc., is powdered or formed into a sheet so as to be adhered to the sealing member side (for example, see the following patent documents 1 and 2). In addition, a technique is disclosed in which a water-capturing film is formed on the entire surface on the sealing member side (for example, see the following patent document 3).

[Patent Document 1] Japanese Laid-open Patent No. 2001-111948,

[Patent Document 2] Japanese Laid-open Patent No. 2002-352980, and

[Patent Document 3] Japanese Laid-open Patent No. 2000-68048

However, with the techniques disclosed in the patent documents 1 and 2, a problem arises in that a step of adhering the desiccant which is powdered or in the form of the sheet to the sealing member is needed and the desiccant needs a space to be disposed, by which the sealing space must be enlarged, for example. Furthermore, when a display area of the self-emitting panel is enlarged, it takes time to arrange the powdery desiccant at many locations, so that the sheet-like desiccant itself is enlarged and another problem arises in that an adhesive strength, of the sheet-like desiccant, with respect to the sealing member decreases. When the sheet-like desiccant is enlarged and the adhesive strength with respect to the sealing member decreases, part of the sheet-like desiccant separates and comes into contact with the organic EL device, which leads to leak etc. Thus, there is a possibility of influencing a screen of the display. Since the powdery desiccant tends to be scattered inside the sealing space, there is another problem in that the arrangement of the desiccant at a number of locations may cause the scattering to become worse.

Further, since the water-capturing film as disclosed in patent document 3 does not have a moisture absorption function, another problem arises in that the use of the organic EL device for a long time causes the degradation factors to be released again into the sealing space, for example.

### SUMMARY OF THE INVENTION

In order to solve the problems as mentioned above and to attain objects, the present invention provides a sealing member which is joined to a substrate of a self-emitting panel and isolates a self-emitting device provided on the self-emitting panel from open air, wherein film formation is carried out on a base material of the above-mentioned sealing member such that functional layers each having insulating properties and adjusting humidity inside a sealing space are formed on a surface facing the inside of the above-mentioned sealing space formed by the above-mentioned sealing member and the above-mentioned substrate, and a surface joined to the above-mentioned substrate.

Further, a self-emitting panel in accordance with the present invention is characterized by having a substrate, a self-emitting device in which at least a light emitting layer is provided between a pair of electrodes on the above-mentioned substrate, and a sealing member which is stacked on the above-mentioned substrate and isolates the above-mentioned self-emitting device from open air, wherein the above-mentioned sealing member is arranged such that functional layers each having insulating properties and adjusting humidity inside a sealing space are formed on a surface facing the inside of the above-mentioned sealing space formed by the above-mentioned sealing member and the above-mentioned substrate, and the surface joined to the above-mentioned substrate.

Further, a method of manufacturing the self-emitting panel in accordance with the present invention is a method of manufacturing the self-emitting panel in which at least a light emitting layer is formed between a pair of electrodes on a substrate, and characterized by comprising: a functional film formation step, for a sealing member joined to the above-mentioned substrate, of forming functional layers each having insulating properties and adjusting humidity inside a sealing space, on a surface facing the inside of the above-mentioned sealing space formed by the sealing member and the above-mentioned substrate, and a surface joined to the above-mentioned substrate; and a sealing step of joining the above-mentioned sealing member to the above-mentioned substrate, and isolating the above-mentioned self-emitting device from open air.

### BRIEF DESCRIPTION OF THE DRAWINGS

FIG. 1A is a sectional side elevation showing a structure of a self-emitting panel in accordance with an embodiment;

FIG. 1B is a sectional side elevation showing another structure of the self-emitting panel in accordance with an embodiment;

FIG. 2 is a flow chart for explaining a manufacturing step for the self-emitting panel in accordance with an embodiment;

FIG. 3A is a sectional side elevation showing an example of another sealing member;

FIG. 3B is a sectional side elevation showing an organic EL device before sealing;

FIG. 4 is a sectional side elevation showing an electrode material film forming step;

FIG. 5A is a plan view showing a patterning step for a conductive metal film;

FIG. 5B is a sectional side elevation showing the patterning step for the conductive metal film;

FIG. 6A is a plan view showing a patterning step for a transparent conductive film;

FIG. 6B is a sectional side elevation showing the patterning step for the transparent conductive film;

FIG. 7A is a plan view showing an insulation film formation step;

FIG. 7B is a sectional side elevation showing an insulation film formation step;

FIG. 8 is a view showing a deposition apparatus used for a film forming step;

FIG. 9A is a plan view showing the organic EL panel sealed by a sealing step;

FIG. 9B is a cross section of FIG. 9A taken along line A-A;

FIG. 9C is a cross section of FIG. 9B taken along line B-B; and

FIG. 10 is a sectional side elevation showing an example of a structure of the sealing member corresponding to a large-sized organic EL panel.

### DESCRIPTION OF THE PREFERRED EMBODIMENTS

### Embodiments

With reference to accompanying drawings, preferred embodiments of a sealing member, a self-emitting panel, and a method of manufacturing a self-emitting panel in accordance with the present invention will be described in detail below. In the embodiments, in accordance with a sealing method using a hermetic-sealing method, there are provided a sealing member which can maintain a sealing space at fixed humidity, a self-emitting panel with such a sealing member and good quality, and a method of manufacturing the self-emitting panel, which simplifies the manufacture and provides the manufacture with low cost.

The sealing member in accordance with the embodiments of the present invention is used as a sealing member at the time of sealing the self-emitting panel by way of the hermetic-sealing method. In the following description, examples using an organic EL device as a self-emitting device will be described.

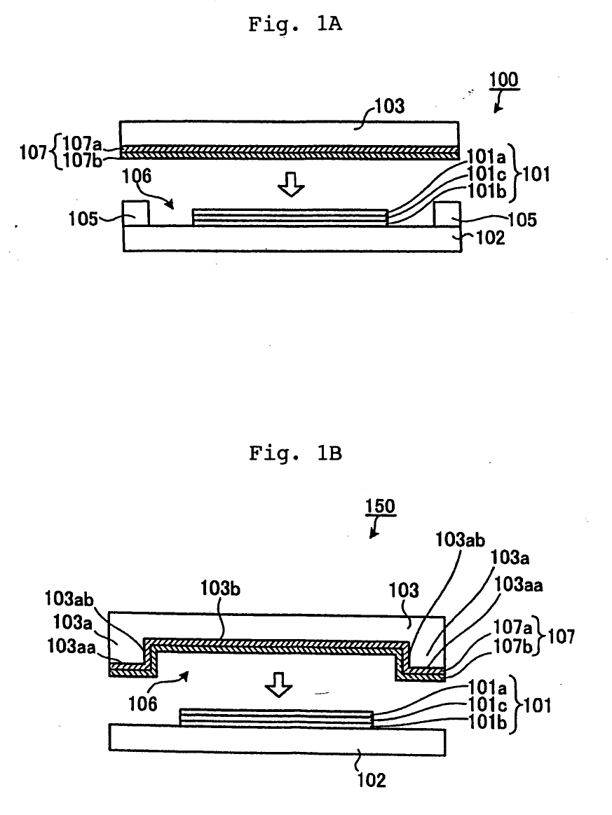

FIG. 1A is a sectional side elevation showing a structure of the self-emitting panel in accordance with the embodiments. This self-emitting panel 100 is constituted by a substrate 102 provided with a self-emitting device 101, and a sealing member 103. The self-emitting device 101 is arranged such that a light emitting layer 101c is provided between a pair of electrodes 101a and 101b on a substrate 102. By using the organic light emitting layer made of an organic material as the light emitting layer 101c, the self-emitting device 101 can be used as the organic EL device. The details of the organic EL device will be described later.

A metal material, a glass material, a plastic material, a quartz material, etc. may be used as a constituent material for the sealing member 103. The sealing member 103 as shown in FIG. 1A is formed in the shape of a plate. In this case, the sealing member 103 is joined (sealed) to the substrate 102 through a spacer 105 provided on the substrate 102. This sealing member 103 isolates the self-emitting device 101 from open air.

Then, film formation is carried out on a base material of the sealing member 103 such that functional layers 107 each having insulating properties and adjusting humidity inside a sealing space 106 are formed on a surface facing the inside of the sealing space 106 formed by the sealing member 103 and the substrate 102, and a surface joined to the substrate 102.

The functional layers 107 comprise a moisture retention functional layer 107a and a moisture absorption functional layer 107b. The moisture retention functional layer 107a keeps the humidity inside the sealing space 106 constant. Further, the moisture absorption functional layer 107b absorbs the moisture (water, bled gas released from adhesives at the time of sealing, etc.) inside the sealing space 106. These functional layers 107 are formed of a material having insulating properties. The functional layers 107 may also be formed only by the moisture retention functional layer 107a or the moisture absorption functional layer 107b.

In the example as shown in FIG. 1A, the film formation is carried out such that the moisture retention functional layer 107a is first formed on the base material, the moisture absorption functional layer 107b is then stacked on the moisture retention functional layer 107a. In addition, it is not limited to the formation by way of the stacking, but it may only have two layers, when forming the moisture retention functional layer 107a and the moisture absorption functional layer 107b.

FIG. 1B is a sectional side elevation showing another structure of the self-emitting panel in accordance with an embodiment. A self-emitting panel 150 as shown in FIG. 1B differs in the shape of the sealing member 103. In order to form the sealing space 106, the sealing member 103 is arranged such that a recess 103b is formed in the central part by etching, polishing, etc., thus causing the circumference of the recess 103b to be a projection 103a. As the material of the sealing member 103 as shown in FIG. 1B, the glass material is shown by way of example, however it may be a metal material or another material. It is possible to design it in the form suitable to the material.

The film formation is carried out on the base material which constitutes the sealing member 103 such that the functional layers 107 each having insulating properties and adjusting the humidity inside the sealing space 106 are formed on the surface facing the inside of the sealing space 106 formed by the sealing member 103 and the substrate 102, and the surface joined to the substrate 102. By the surface facing the inside of the sealing space 106 is meant a side 103ab, facing the sealing space 106, of the projection 103a and the recess 103b. By the surface joined to the substrate 102 is meant a bottom 103aa of the projection 103a. By way of the film formation, the functional layers 107 are formed continuously throughout the bottom 103aa of the projection 103a—the side 103ab—the recess 103b. As mentioned above, the functional layers 107 comprise the moisture retention functional layer 107a and the moisture absorption functional layer 107b.

Since the projection 103a is equivalent to the spacer 105 as shown in FIG. 1A, the sealing member 103 in the shape shown in FIG. 1B does not need to be provided with the spacer 105. When the sealing member 103 is constituted by a conductive metal material, such as stainless steel etc., it is possible not to comprise the spacer 105. In other words, this is because the projection 103a (bottom 103aa) part of the sealing member 103 joined to the substrate 102 is covered with the functional layers 107 having insulating properties. Further, a lead wire is provided on the substrate 102 from a part of the self-emitting device 101 to an edge of the substrate 102, beyond a joining part of the sealing member 103. However, without providing the spacer 105 as mentioned above, the sealing member 103 can be directly joined to the substrate 102, because it is covered with the functional layers 107 having insulating properties.

In the example as shown in FIG. 1B, the part joined to the substrate 102 is the projection 103a of the sealing members 103. Alternatively, it is possible to form a flange part at the end of the sealing member 103, and this flange part can also be arranged to be joined to the substrate 102.

The functional layer 107 which is described with reference to FIGS. 1A and 1B and which is formed at the sealing member 103 may be arranged by removing only the part joined to the substrate 102 by way of etching and a physical excision method. However, the spacer 105 is provided when the sealing member 103 is in the plate-like shape as shown in FIG. 1A, or when it is constituted by the conductive metal material as shown in FIG. 1B. However, it is also possible to mix a glass spacer etc. into the adhesive used for the part joining together the substrate 102 and the sealing member 103. In this case, a plate-like member can be used for the sealing member 103.

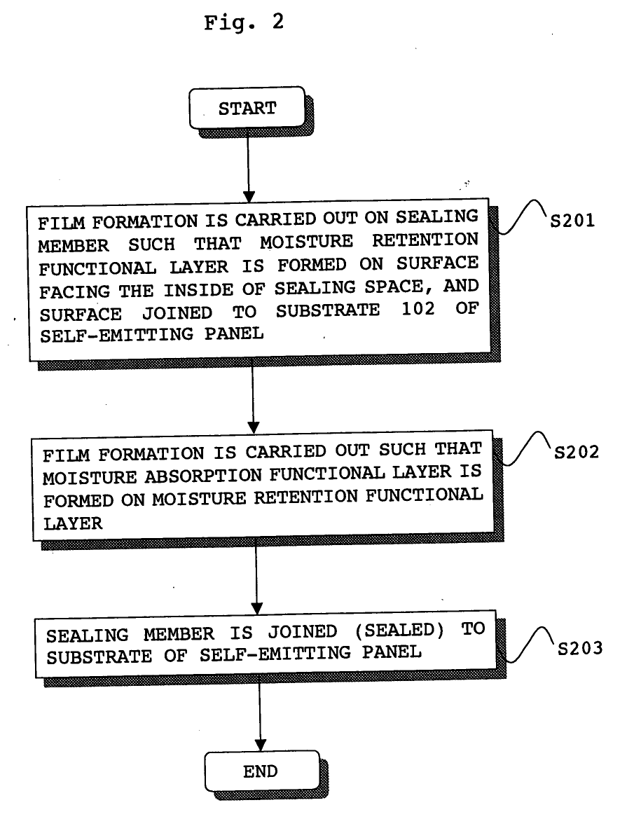

FIG. 2 is a flow chart for explaining a manufacturing process of the self-emitting panel in accordance with the embodiments. In FIG. 2, there are described a step of producing the functional layer 107 with respect to the sealing member 103 and a step of joining (sealing) the sealing member 103 to the self-emitting panel 100, 150 (substrate 102) among the manufacturing steps of the self-emitting panel 100, 150.

Firstly, the film formation is carried out on the sealing member 103 such that the moisture retention functional layer 107a is formed on the surface facing the inside of the sealing space 106, and the surface joined to the substrate 102 of the self-emitting panel 100, 150 (Step S201). Next, the film formation is carried out such that the moisture absorption functional layer 107b is formed on the moisture retention functional layer 107a (Step S202). The moisture absorption functional layer 107b is stacked on the moisture retention functional layer 107a, so that the functional layer 107 is formed. In addition, as mentioned above, it is not necessary for the functional layer 107 to stack the moisture absorption functional layer 107b on the moisture retention functional layer 107a, but at least two layers may only be formed without stacking. Further, the functional layer 107 may also be formed only by the moisture retention functional layer 107a or the moisture absorption functional layer 107b.

Then, as shown in FIG. 1A or FIG. 1B, the sealing member 103 having formed thereon the functional layer 107 is joined to the substrate 102 of the self-emitting panel 100, 150, and sealed by way of the hermetic-sealing method (Step S203).

According to the embodiments as described above, the functional layer 107 provided on the sealing member 103 can absorb the moisture or alternatively absorb and retain the moisture inside the sealing space 106, thus absorbing degradation factors, such as water in the sealing space 106. Furthermore, it is possible to prevent the absorbed degradation factors from being released again. Thus, it is possible to prevent the degradation of the self-emitting device and provide the self-emitting panel which is reliable over a long time.

Further, since the functional layer 107 is formed on the surface of the sealing member 103 in the shape of a film, the functional layer 107 can easily be formed over the whole surface of the sealing member 103 regardless of a size of the sealing member 103. Thus, even if the display of the self-emitting panel is enlarged in size, the functional layer 107 can be formed on the correspondingly enlarged sealing member 103 at the surface facing the inside of the sealing space 106. Since the functional layer 107 has insulating properties, and is continuously formed also on the part joined to the substrate 102, the sealing member 103 can be directly joined to the substrate 102, whereby the sealing work can be carried out easily. In addition, except when employing a display panel in the shape of a conventional rectangle (square), the present invention is very effective also in the case of display panels in infinite shapes, such as circular, a star type, a polygon, and a character, non-planar shapes, such as a spherical shape, a column shape, etc.

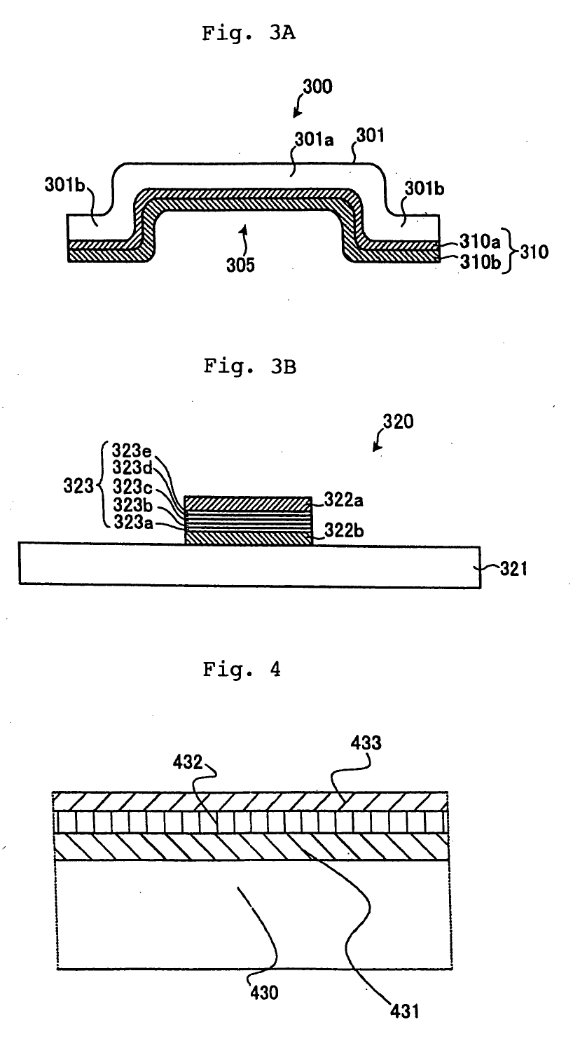

FIG. 3A is a sectional side elevation showing an example of the sealing member. A base material 301 of a sealing member 300 as illustrated is constituted by a sealing space formation part 301a for forming a sealing space 305, and a flange part 301b provided for the whole circumference of the sealing space formation part 301a. The base material 301 can be formed by using various materials, such as a conductive metal material (such as stainless steel etc.), glass, a plastic, etc.

When the base material 301 is formed with the metal material, such as stainless steel, a plate-like component is subjected to manufacture methods, such as press molding, deep drawing, etc., so as to form the sealing space formation part 301a and the flange part 301b.

Then, the film formation is carried out on the base material 301 such that the functional layers 310 each having insulating properties and adjusting humidity inside the sealing space 305 are formed on a surface facing the inside of the sealing space 305 and the flange part 301b joined to the substrate 102 (see FIG. 1A etc.). The functional layer 310 is constituted by a moisture retention functional layer 310a which keeps the humidity inside the sealing space 305 constant, and a moisture absorption functional layer 310b which absorbs moisture inside the sealing space 305. These functional layers 310 are formed of a material having insulating properties.

The film formation is carried out such that the moisture retention functional layer 310a and the moisture absorption functional layer 310b are formed on a surface of the base material 301 by way of manufacturing methods, such as coating, printing, dipping, sputtering, deposition, lamination, adhesion, etc. For this reason, a step of providing a desiccant at the base material 301 can be omitted. Further, in order to provide the desiccant, it is not necessary to form a space (recess) for accommodating the desiccant in the sealing member 300, and it is not necessary to apply a special step and a formation step to the base material 301.

When using the glass material as the base material 301 of the sealing member 300, a surface of plate-like glass is subjected to a process, such as blast etching, chemical etching, etc. so that the sealing space formation part 301a to be the recess can be formed.

Further, when both the substrate 102 (see FIG. 1A etc.) of the self-emitting panel 100 and the base material 301 of the sealing member 300 employ the glass material, there is a possibility that incidence light from the substrate 102 surface may be reflected by a part of the sealing member 300, and projected on a surface of the substrate 102.

However, by forming the above-mentioned moisture absorption functional layer 310b or moisture retention functional layer 310a on the base material 301 of the sealing member 300, it is possible to prevent this light from being reflected and improve visibility.

Further, by forming the moisture retention functional layer 310a between the base material 301 and the moisture absorption functional layer 310b, an adhesive strength of the moisture absorption functional layer 310b with respect to the base material 301 is raised, and it is possible to prevent the moisture absorption functional layer 310b containing water from separating and falling from the base material 301.

Below, an organic EL device as the self-emitting device will be described. The organic EL device is also referred to as an organic electroluminescence (OEL) device, an organic light emitting diode (OLED) device, and an electric field light-emitting source. A polymer material or a low molecule material is used as an organic material (luminescent material, charge injection/transport material, etc.) which constitutes the organic EL device. In the present invention, an example using the low molecule material as the organic material will be described, and a device structure between a pair of electrodes is referred to as “organic EL device”.

FIG. 3B is a sectional side elevation showing the organic EL device before sealing. The organic EL device 320 is provided with a pair of electrodes on a substrate 321 which are an anode (anode, electron hole injecting electrode) 322b and a cathode (cathode, electron injecting electrode) 322a, and an organic layer 323 including a luminescence layer is sandwiched between these anode 322b and cathode 322a. By applying a voltage across the anode 322b and the cathode 322a, an electron hole injected from the anode 322b into and conveyed in the organic layer 323, and an electron injected from the cathode 322a into and conveyed in the organic layer 323 are recombined in the light emitting layer within the organic layer 323, so that the recombination allows light-emission.

Now, due to material development and development progress of a manufacture process, one that uses the low molecule material is produced commercially as a display. The organic layer 323 is arranged by stacking layers having a plurality of functions. A layer structure having, in order from bottom to top, an electron hole injecting layer 323a, an hole transporting layer 323b, an organic electroluminescence light emitting layer 323c, an electron transporting layer 323d, and an electron injecting layer 323e is common. Each layer may be formed of a single organic material. Alternatively, it may be formed of a plurality of mixed materials (mixed layer), or a polymer binder in which a functional material (charge transport function, light-emitting function, charge blocking function, optical function, etc.) of an organic material or an inorganic material is dispersed. Further, some of the layers use a buffer function of preventing the organic layer 323 from being damaged when forming the cathode 322a by way of a sputtering method, or a planarization function of preventing irregularities due to a film forming process.

Not only the above-mentioned structures, but there are also one in which an upper electrode of a pair of electrodes is an anode (correspondingly a lower electrode is a cathode), one in which the organic electroluminescence light emitting layer 323c has a plurality of layers, one in which a plurality of organic EL devices are stacked (SOLED: Stacked OLED), one in which a charge generating layer is interposed between the cathode 322a and the anode 322b (multi-photon device), one in which a layer, such as the hole transporting layer 323b, is omitted, one in which a plurality of hole transporting layers are stacked, one in which only one layer of the organic layer 323 is provided (there is no layer boundary in which each functional layer is formed continuously), etc. In addition, the present invention does not limit the device structure of the organic EL device 320, but it allows a display in which an organic EL device of a plurality of emission colors like full color and an area color, and a display of monochrome emission.

(Manufacture Process of Organic EL Device)

Below, an example of a manufacture process of the organic EL device will be described. The manufacture process of the organic EL device comprises a pre-processing step as will be described below, a film formation step using a deposition apparatus, and a sealing step using the sealing member in accordance with the present invention as mentioned above. The pre-processing step includes an electrode material film formation step, a step of patterning a conductive metal film, a step of patterning a transparent conductive film, and an insulation film formation step. Of course, the present invention is not limited only to a method of forming a film of a low molecule material by way of a deposition process as will be described below, but the film formation may be achieved by way of an LITI process in which a film forming material is formed into a film of a donor sheet beforehand, and then the pattern is transferred by means of laser, a method in which a polymer material is formed as a film by way of a printing process or an ink-jet process, and a manufacture process using a photo-bleaching process in which an organic material formed as a film is irradiated with an electromagnetic wave etc., and light-emitting performance etc. is adjusted.

FIG. 4 is a sectional side elevation showing an electrode material film forming step. Firstly, a substrate 430 has formed thereon films in the order of a buffer layer 431, a transparent conductive film 432, and a conductive metal film 433. Generally, glass or a plastic is used for the substrate 430, SiO2 (silicon dioxide), TiO2 (titanium oxide), etc. are used for the buffer layer 431, ITO (indium-tin oxide), IZO (indium-zinc oxide), etc. are used for the transparent conductive film 432, and Cr (chromium), Al (aluminum), Ag (silver), etc. are used for the conductive metal film 433. Most preferred formation example is one in which glass is used for the substrate 430, ITO is used for the transparent conductive film 432, and Cr is used for the conductive metal film 433. Further, when glass having an alkali component is used for the substrate 430 and the glass contains an impure element (alkaline metal, Ca, Na, etc.), the buffer layer 431 is used for blocking penetration of the impure element.

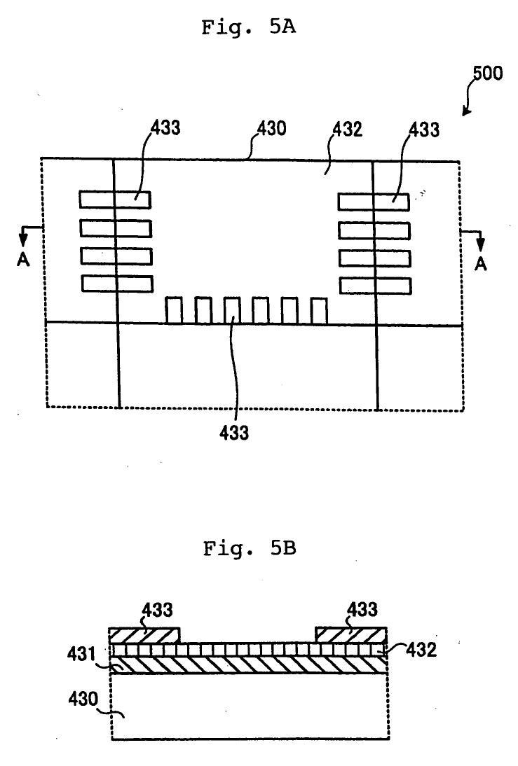

FIG. 5A is a plan view showing a patterning step for the conductive metal film. Further, FIG. 5B is a sectional side elevation showing a patterning step for the conductive metal film. This FIG. 5B is the sectional side elevation taken along line A-A in FIG. 5A. In the electrode material film forming step, the buffer layer 431, the transparent conductive film 432, and the conductive metal film 433 are formed in order on the substrate 430. Then, the patterning of lead wires of the lower electrode and the upper electrode is carried out on the uppermost conductive metal film 433 by way of a photo-lithography process. Shown in FIG. 5A is a plan view after patterning the substrate 430 formed at a part of a substrate 500 for multi-panel processing. As shown in these figures, the part where the conductive metal film 433 on the uppermost surface of the substrate 430 is removed is in a situation where the transparent conductive film 432 is exposed.

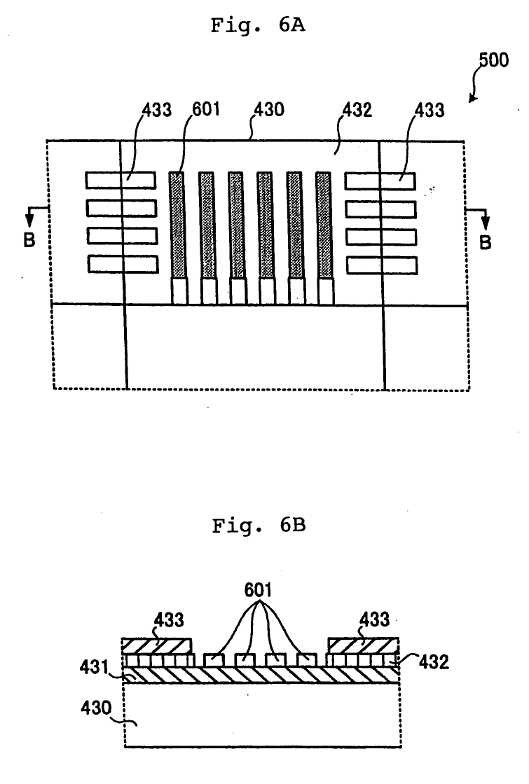

FIG. 6A is a plan view showing the patterning of the transparent conductive film. Further, FIG. 6B is a sectional side elevation showing the patterning of the transparent conductive film. This FIG. 6B is the sectional side elevation taken along line B-B of FIG. 6A. Further, these FIGS. 6A and 6B are figures after patterning the substrate 430. In the patterning step for the transparent conductive film, the patterning is carried out for the transparent conductive film 432 exposed on the substrate 430 in the patterning step for the conductive metal film. The whole exposed part of the transparent conductive film 432 is removed by patterning except for parts 601 (shaded) as shown in FIG. 6A. The remaining parts 601 are part of the lower electrode and the lead wire, where a surface of the lower electrode of the part 601 may be ground so as to smooth the surface of the lower electrode. Further, the lower electrode surface may be chemically etched and smoothed by means of an etchant (etching solution) used for the lower electrode, which is diluted.

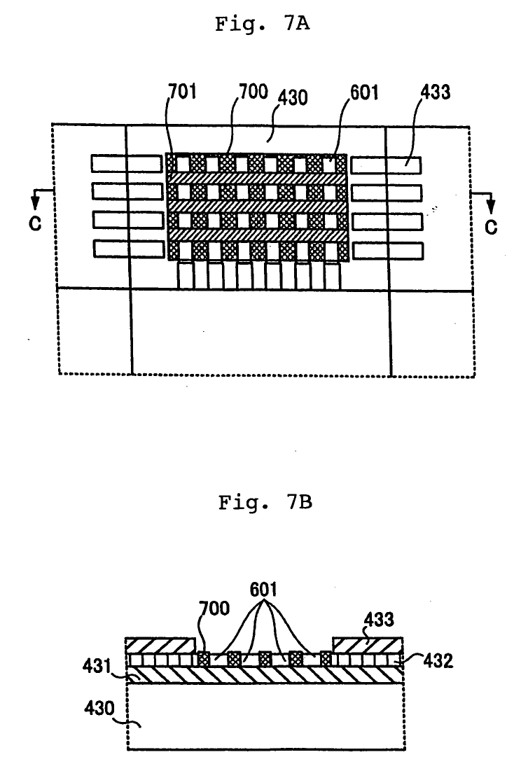

FIG. 7A is a plan view showing an insulation film formation step. Further, FIG. 7B is a sectional side elevation showing an insulation film formation step. Shown in FIG. 7A is a plan view after patterning the substrate 430. Further, FIG. 7B is a sectional side elevation taken along line C-C of FIG. 7A. In the insulation film formation step, patterning formation is carried out to provide an insulation film of photosensitive polyimide etc. between lines of the lower electrodes (parts 601 in the figure) by way of the photo-lithography process. As shown, insulation films 700 are formed among parts 601 to which the patterning is applied by patterning the transparent conductive film. It is possible to form at least an upper electrode partition 701 (upper electrode separator) for carrying out the patterning of the upper electrodes. Alternatively, it is possible to carry out the patterning of the upper electrode by using a mask for forming a film at the time of forming the film by means of a deposition apparatus to be described later. Simultaneously, a UV (ultraviolet rays) washing step is carried out in order to remove an organic matter and water at the surface of the substrate 430,

The electrode material film forming step through the electrode material film forming step as described above are pre-processing steps of the manufacture process for the organic EL device.

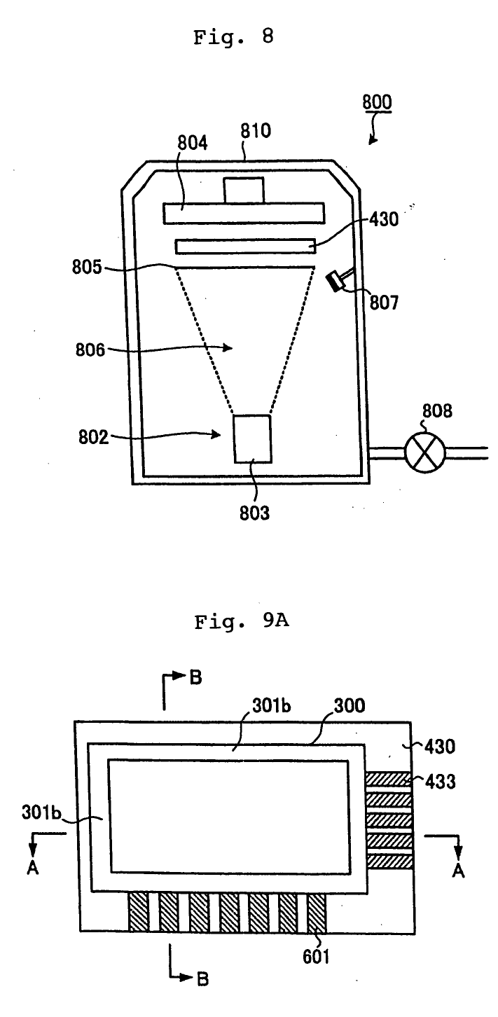

After completing the pre-processing steps as described above with reference to FIGS. 4-7, a film forming step is carried out by using the deposition apparatus as will be explained referring to FIG. 8. FIG. 8 is a view showing the deposition apparatus used for the film forming step. A deposition apparatus 800 includes a chamber 810 to which a valve 808 is connected. A heating means 802, a magnet unit 804, a mask 805 for film forming, and a film forming monitor 807 are provided in the chamber 810. The substrate 430 formed in the electrode material film forming step through the electrode material film forming step as described above is conveyed to the deposition apparatus 800, and is safely disposed on a surface of the mask 805 for film forming in the chamber 810 maintained under vacuum. Furthermore, the substrate 430 and the mask 805 for film forming are brought into close contact with each other by the magnet unit 804. The heating means 802 is provided with a deposition source 803, over which the mask 805 for film forming supported by a mask frame (not shown) is disposed.

An organic material inserted into the deposition source 803 heated by the heating means 802 sublimates or evaporates after being melt, and turns into a film forming material (vapor) 806 so as to form an organic film on the substrate 430. By using such a deposition apparatus 800, it is possible, for the film forming step of forming an organic material layer as a film, to employ any organic material which can be used for the organic EL device.

The organic material layer is formed of one of the hole transporting layer, the organic light emitting layer, the electron transporting layer, etc., or alternatively stacked by them as a composite structure. Various organic materials including CuPc, and NPB and Alq3 can be used. When using the organic EL device for the self-emitting panel which allows a plurality of emission colors, the organic light emitting layer can be formed in various patterns corresponding to the emission color of each pixel. Further, it is possible to form the hole transporting layer, the electron transportinging layer, etc. so as to have a film thickness corresponding to the emission color.

A particular example of film forming will be described. Firstly, CuPc of the hole injecting layer is stacked on the insulation film 700 shown in FIG. 7A and FIG. 7B, by way of deposition, to have a thickness of 50 nm, and 50 nm 4,4′-bis[N-(1-naphthyl(-N-phenylamino]biphenyl (NPD) is stacked as the hole transporting layer. Then, each light emitting layer of RGB is formed on an upper surface of the hole transporting layer formed as a film such that a material is separately applied to a film forming area of each light emitting layer by using a film forming mask which has a pattern. At this stage, the mask for film forming which has the film forming pattern of a B light emitting layer is disposed between a film forming source and the substrate, and the B light emitting layer is stacked such that a host material of 4,4′-bis(2,2-diphenylvinyl)-biphenyl (DPVBi) and 4,4′-bis(2-carbasolevinylene)biphenyl (BCzVBi) as 1% by weight of a dopant (doping coexistence material) are deposited to be 50 nm thick. Subsequently, the mask for film forming which has the film forming pattern of a G light emitting layer is disposed between the film forming source and the substrate, and 50 nm coumarin 6 is stacked as a G light emitting layer by way of deposition. Then, the mask for film forming which has the film forming pattern of R light emitting layer is disposed between the film forming source and the substrate, and an R light emitting layer is stacked such that a host material of tris(8-quinolinole)aluminum (Alq3) and 4-(dicyanomethylene)-2-methyl-6-(p-dimethylaminostyryl)-4H-pyran (DCM) as 1% by weight of a dopant are deposited to be 50 nm thick, on which Alq3 is deposited as an electron transporting layer to be 20 nm thick, and aluminum (Al) is deposited as a cathode to be 150 nm thick, so that an organic material film is formed.

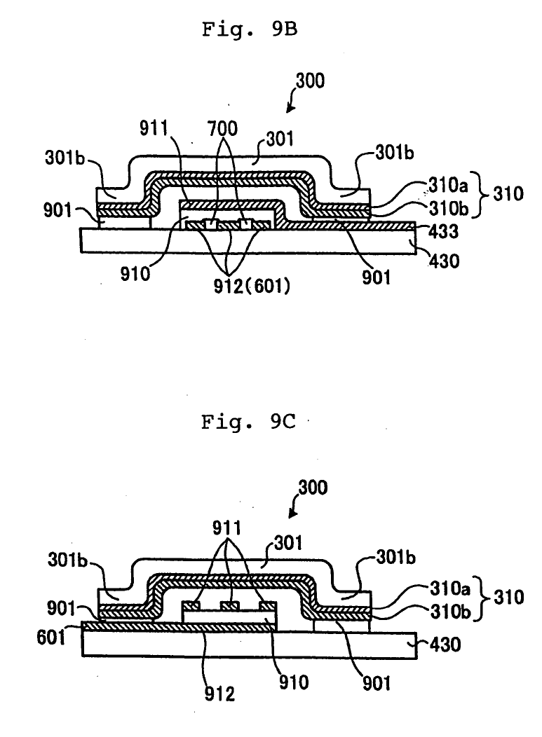

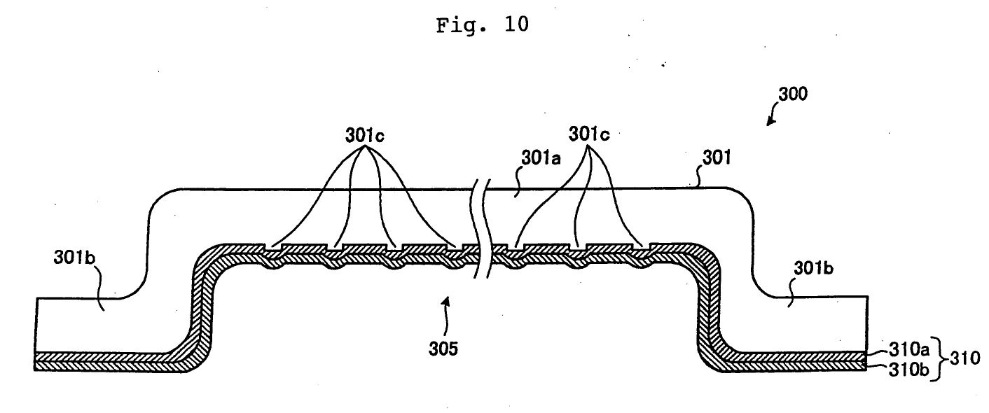

FIG. 9A is a plan view showing the organic EL panel sealed by way of the sealing step, FIG. 9B is a cross section along line A-A of FIG. 9A, and FIG. 9C is a cross section along line B-B of FIG. 9A.

Reference numerals 910, 911, and 912 respectively denote an organic material layer, an upper electrode and a lower electrode. The substrate 430 after the organic material film forming step as in FIG. 8 is subjected to an emission inspection step, then it is carried into a sealing room where a vacuum atmosphere is changed to an inactive gas atmosphere N2. At the same time, the sealing member 300 in accordance with the present invention, as mentioned above is carried into the sealing room. Subsequently, an adhesives 901 made of an ultraviolet curing type epoxy resin and mixed with a suitable quantity (approximately 0.1 to 0.5% by weight) of glass spacer having a grain size of 1 to 300 is applied to a place, on the substrate 430, corresponding to the flange part 301b of the sealing member 300 by using a dispenser etc. Then, the substrate 430 to which the adhesive 901 is applied and the sealing member 300 are joined together through the adhesive 901, and the adhesive 901 is irradiated with ultraviolet rays from the substrate 430 side so as to be cured.

The sealing member 300 has formed therein the moisture retention functional layer 310a and the moisture absorption functional layer 310b as the functional layer 310 which has insulating properties at the flange part 301b. The moisture absorption functional layer 310b has a function which absorbs the moisture etc. of the sealing space 305. For example, it is formed of a layer containing a desiccant or a moisture absorption agent which may be a physical drying material, such as zeolite, a carbon nanotube, etc., a chemical desiccant, such as an alkaline earth metal oxide, an alkaline metal oxide, a metal halide, and chlorine peroxide, etc., or an organic metal complex dissolved in petroleum solvents, such as toluene, xylene, and an aliphatic organic solvent. The moisture retention functional layer 310a has a function which encloses the moisture etc. absorbed by the moisture absorption functional layer 310b. For example, it is constituted by a layer containing a moisture retaining resin, such as a nylon, hot-melt type resin, etc.

Since the functional layer 310 which has such insulation is used, the sealing member 300 can be joined to the substrate 430, even if the adhesive is not mixed with the glass spacer etc. Especially, even if the sealing member 300 is constituted by the electrically conductive metal material, such as stainless steel etc., they can be joined together without using the adhesive mixed with the spacer or the glass spacer which are separately prepared.

The manufacture method of the organic EL device as described above has advantages in that a step of providing the sealing member with a drying means (such as a powdery or sheet-like desiccant, SrO, CaO, etc.) in the sealing step can be omitted as compared with the conventional organic EL device. Furthermore, the moisture absorption functional layer adsorbs the degradation factor which exists in the sealing space and prevents the degradation factor adsorbed by the moisture retention functional layer from being released into the sealing space, so that the self-emitting panel reliable over a long time can be provided.

FIG. 10 is a sectional side elevation showing an example of a structure of the sealing member corresponding to a large-sized organic EL panel.

As the organic EL panel is enlarged (for example, a display size is 17 inches or more), the organic EL device and the substrate 430 (for example, see FIG. 4) is enlarged, and the sealing member 300 is also enlarged similarly. In this case, as shown in FIG. 10, in order to prevent bending etc. and to acquire predetermined rigidity, a plurality of reinforcement portions 301c in the shape of projections, such as a rib, thick part, etc., are formed at the base material 301 of the sealing member 300. These reinforcement portions 301c may be plural and provided in the vertical and lateral directions of the base material 301.

Since the functional layer 310 is formed as a film by way of deposition etc., even if the reinforcement portions 301c are formed on the base material 301 in the shape of the projections, then they can be easily formed to suit the shape of the base material 301. When the sealing member 300 is enlarged, it is conventionally necessary to fix the desiccant formed in the shape of powder or sheet to the base material 301. One that is powdery needs a larger provision area and more work. One that is in the shape of the sheet has a weak junction at the reinforcement portions 301c so that the sheet tends to peel off. However, the functional layer 310 in which the film formation is carried out according to the present invention can prevent the peel-off even if the reinforcement portions 301c protrude and the sealing member 300 is enlarged, thus allowing the function to be exhibited.

According to the embodiments as described above, the functional layer 310 provided at the sealing member 300 can absorb and retain the moisture etc. inside the sealing space 305, thereby absorbing the degradation factors, such as the moisture of the sealing space 305 etc., and preventing the absorbed degradation factors from being released again. Thus, it is possible to prevent the degradation of the self-emitting device. This functional layer 310 has insulating properties, and is also continuously formed over the portions joined to the substrate 430 so that the sealing member 300 can be directly joined to the substrate 430, whereby the sealing can be carried out easily.

Further, since the functional layer 310 is formed on the surface of the sealing member 300 in the shape of a film, the functional layer 310 can easily be formed over the whole surface of the sealing member 300 regardless of the size of the sealing member 300. Thus, even if the display area of the self-emitting panel is enlarged, the correspondingly enlarged sealing member 300 allows the functional layer 310 to be formed on the surface facing the inside of the sealing space 305.

Further, since the functional layer 310 can be formed on the sealing member 300 in the stage before sealing the sealing member 300, the sealing can be done easily. The formation of the functional layer 310 can be carried out in any stage after forming the sealing member 300. For example, where the base material 301 of the sealing member 300 is constituted by the glass material, and of the shape having the sealing space formation part 301a to be the recess, the surface of the plate-like glass is subjected to the process, such as blast etching, chemical etching, etc., and the sealing space formation part 301a to be the recess is formed, then the functional layer 310 is formed. Further, where the base material 301 of the sealing member 300 is constituted by the metal material, after forming the functional layer 310 for the plate-like sealing member 300, the flange part 301b can also be formed by applying pressure to the sealing member 300.

Further, where the base material 301 of the sealing member 300 is the metal material, both the moisture retention functional layer 310a which is the functional layer 310, and the moisture absorption functional layer 310b are insulative, so that the base material 301 of the sealing member 300 can easily be insulated from the lead wires 433, 601 formed on the substrate 430, and the sealing work does not need a special insulating process.

1. A sealing member for isolating, from open air, at least a self-emitting device of a self-emitting panel having the self-emitting device provided on a substrate, wherein
film formation is carried out on a base material of said sealing member such that functional layers each having insulating properties and adjusting humidity inside a sealing space are formed on a surface facing the inside of the sealing space formed by said sealing member and said substrate, and a surface joined to said substrate.

2. The sealing member as claimed in claim 1, wherein said functional layer comprises a moisture absorption functional layer which absorbs the humidity inside said sealing space or said moisture absorption functional layer and a moisture retention functional layer which keeps the humidity inside said sealing space constant.

3. The sealing member as claimed in claim 2, wherein said functional layer comprises the moisture retention functional layer formed on said base material, and the moisture absorption functional layer stacked and formed on said moisture retention functional layer.

4. The sealing member as claimed in any one of claims 1 to 3, wherein said base material is of a conductive material.

5. The sealing member as claimed in claim 1, wherein said base material is of a conductive material and has a flange part which forms said sealing space and is joined to said substrate, and said functional layer is continuously formed over the whole surface facing the inside of said sealing space and said flange part.

6. The sealing member as claimed in claim 1, wherein part of said functional layer formed on said base material is removed, said part being joined to said substrate, and said base material is joined to said substrate through an insulative spacer disposed at said part to be joined.

7. A self-emitting panel having a substrate,at least a self-emitting device in which a light emitting layer is provided between a pair of electrodes on said substrate, and a sealing member which is stacked on said substrate and isolates said self-emitting device from open air, wherein
said sealing member is arranged such that functional layers each having insulating properties and adjusting the humidity inside said sealing space are formed on a surface facing the inside of said sealing space formed by said sealing member and said substrate, and the surface joined to said substrate.

8. The self-emitting panel as claimed in claim 7, wherein said self-emitting device is an organic EL device.

9. A method of manufacturing at least a self-emitting device of a self-emitting panel in which at least a light emitting layer is formed between a pair of electrodes on a substrate, said method comprising:
a functional film formation step, for a sealing member joined to said substrate, of forming functional layers each having insulating properties and adjusting humidity inside a sealing space, on a surface facing the inside of said sealing space formed by the sealing member and said substrate, and a surface joined to said substrate, and a sealing step of joining said sealing member to said substrate, and isolating said self-emitting device from open air.

10. The method of manufacturing the self-emitting panel as claimed in claim 9, wherein said functional film formation step comprises:
a moisture retention functional layer formation step of forming a moisture retention functional layer which keeps the humidity inside the sealing space constant on said substrate, and
a moisture absorption functional layer formation step of forming a moisture absorption functional layer which is stacked on said moisture retention functional layer, and absorbs moisture inside said sealing space.
